(19) United States
(12) Patent Application Publication
(10) Pub. No.: US 2023/0323878 A1
(43) Pub. Date: Oct. 12, 2023

(54) DRY VACUUM PUMP AND MANUFACTURING METHOD

(71) Applicant: PFEIFFER VACUUM, Annecy (FR)

(72) Inventors: Laetitia POPIN, Annecy (FR); Philippe D'HARBOULLE, Annecy (FR); Igor FORESTIER, Annecy (FR); Sebastien BARDEL, Annecy (FR); Emmanuel BEAUJON, Annecy (FR)

(73) Assignee: PFEIFFER VACUUM, Annecy (FR)

(21) Appl. No.: 17/768,071

(22) PCT Filed: Sep. 24, 2020
(86) PCT No.: PCT/EP2020/076797

§ 371 Date: Apr. 11, 2022

(30) Foreign Application Priority Data
Oct. 14, 2019 (FR) FR1911370

(51) Int. Cl. F04C 25/02; F04C 18/12

(52) U.S. Cl. CPC F04C 25/02; F04C 18/126; F04C 2220/12; F04C 2230/91; F04C 2230/41

(57) ABSTRACT

A dry vacuum pump has a stator (2) and two rotors (5) that are accommodated in at least one compression chamber (3) of the stator (2), the rotors (5) being configured to rotate synchronously in opposite directions so as to drive a gas to be pumped between an intake and a delivery of the vacuum pump. The rotors (5) and the compression chamber (3) of the stator (2) are coated with a nickel-phosphorus coating (11) comprising between 9% and 14% phosphorus and having a thickness greater than 20 μm, the nickel-phosphorus coating (11) having undergone a hardening heat treatment comprising a step of heating to a treatment temperature greater than 250° C. for a treatment duration greater than one hour, so as to have a hardness greater than 700 HV.

The invention relates to a dry vacuum pump, such as a vacuum pump of the “Roots” or “claw” type, or of the spiral or screw type or based on another similar principle. The invention also relates to a method for manufacturing such a vacuum pump.

Dry vacuum pumps can be used to evacuate corrosive gases or particularly aggressive particles, such as halogenated gases or abrasive particles, originating notably from the reaction by-products of certain manufacturing methods. Corrosion layers may form at the surface of the components of the vacuum pumps, and this may reduce the functional clearances between the rotors and the stator and modify the performance of the vacuum pumps.

Nickel coatings or polymer coatings of the Teflon® type are generally used to protect cast iron from corrosive attacks.

However, these solutions are not truly satisfactory. Specifically, the intrinsic ductility of these coatings means that, upon the slightest impact or contact, the coating undergoes plastic deformation that creates a bulge-like accumulation of material between the components, and this may entail the risk of the pump seizing.

Another drawback of this type of coating is that, although it improves the resistance of the cast iron to corrosive gases, it does not necessarily protect the vacuum pump from abrasion.

Another solution consists in lowering the temperature of the vacuum pump in order to lower the temperature of the pumped gases and thus reduce the thermal activation of the corrosion kinetics. However, lowering the temperature of the gases promotes their condensation or solidification, notably of the precursors, carrier gases or other reaction by-products. The formation of deposits may then increase, notably the formation of deposits of the polymer, metal or oxide type, and this may also entail the risk of the vacuum pump seizing.

It is also known to use nickel-enriched cast irons, of the Ni-resist type. These cast irons have the advantage of being much more resistant to corrosion and oxidation than traditional cast irons. This material may not, however, be easily substituted for conventional cast iron in order to produce vacuum pump components, since it is difficult to machine and has a very high cost.

An aim of the present invention is to at least partially remedy the aforementioned drawbacks, notably by proposing a vacuum pump that is resistant to corrosive gases and abrasive powders and is not excessively expensive.

To this end, a subject of the invention is a dry vacuum pump having a stator and two rotors that are accommodated in at least one compression chamber of the stator, the rotors being configured to rotate synchronously in opposite directions so as to drive a gas to be pumped between an intake and a delivery of the vacuum pump, characterized in that the rotors and the compression chamber of the stator are coated with a nickel-phosphorus coating comprising between 9% and 14% phosphorus and having a thickness greater than 20 μM, the nickel-phosphorus coating having undergone a hardening heat treatment comprising a step of heating to a treatment temperature greater than 250° C. for a treatment duration greater than one hour, so as to have a hardness greater than 700 H_{V}.

The hardening heat treatment is performed so as to precipitate and crystallize compounds of the nickel-phosphorus coating in order to increase its hardness. The hardening of the coating by heat treatment makes it more brittle as a result of the creation of microcracks in the microstructure of the coating. In the event of mechanical contact between the rotors and the stator or between the rotors, the coating flakes off and is dispersed in the form of dust. It is not deformed into bulges as in the prior art coating but flakes off in the form of fine particles. These particles can be easily evacuated progressively by the pumping without preventing the vacuum pump from continuing to rotate. Seizing can thus be avoided.

Furthermore, the nickel-phosphorus coating makes it possible to avoid the formation of corrosion layers in the vacuum pump. The heat treatment for hardening the coating thus makes it possible to improve the resistance of the vacuum pump to corrosive gases and abrasion.

It also makes it possible to increase the regulation temperature of the body of the stator of the vacuum pump so as to avoid the condensation-solidification of the reaction by-products and therefore to avoid the formation of deposits of condensable entities that are likely to cause the vacuum pump to seize.

The dry vacuum pump may also have one or more of the features that are described below, considered on their own or in combination.

The treatment duration is for example greater than 8 hours. A treatment duration greater than eight hours allows the microstructure of the coating to be made uniform. This treatment duration also makes it possible to limit the internal stresses in the coating and thus to make it tougher. In addition, the treatment duration greater than eight hours allows the hydrogen gas that is trapped in the coating during the phase of depositing the coating to be degassed.

The treatment duration is for example less than 15 hours. A treatment duration greater than 15 hours risks not allowing the desired hardening qualities to be obtained.

The hardness may be between 800 H_{V} and 1000 H_{V}.

The treatment temperature may be less than 350° C.

The nickel-phosphorus coating may comprise between 10% and 13% phosphorus.

The nickel-phosphorus coating has for example a thickness less than or equal to 60 such as 25 μm+/−5 μm.

The vacuum pump has for example at least two pumping stages each defining a compression chamber, the compression chambers of the successive pumping stages being connected in series by at least one inter-stage channel provided in the body of the stator that is also provided with a nickel-phosphorus coating.

More specifically, the nickel-phosphorus coating covers for example all the walls of the vacuum pump that are likely to be in contact with the gas to be pumped.

The body of the stator and the bodies of the rotors are made for example from cast iron or steel.

The vacuum pump may be configured to rotate at more than 40 Hz.

Another subject of the invention is a method for manufacturing a dry vacuum pump, characterized in that it involves the following steps:
a nickel-phosphorus coating comprising between 9% and 14% phosphorus and having a thickness greater than 20 μm is deposited on an internal wall of the stator and on the walls of the rotors, and
the nickel-phosphorus coating of the stator and of the rotors is heat treated with a step of heating to a treatment temperature greater than 250° C. for a treatment duration greater than one hour, so as to have a hardness greater than 700 H_{V}, for example between 800 H_{V} and 1000 H_{V}.

The manufacturing method may have one or more of the features that are described below, considered on their own or in combination.

The treatment duration is for example greater than 8 hours and/or less than 15 hours.

The hardening heat treatment may involve at least one temperature raising step during which the temperature setpoint is increased from ambient temperature to the treatment temperature at a raising rate of between 1° C./min and 3° C./min. These temperature raising rates allow an acceptable compromise to be obtained between a treatment duration that is relatively short for an industrial process and a rate that is slow enough to avoid the creation of excessively violent forces at the interface situated between the nickel-phosphorus coating and the wall of the stator or at the interface situated between the nickel-phosphorus coating and the walls of the rotors. Specifically, the coefficients of thermal expansion are slightly different.

The nickel-phosphorus coating is for example deposited on the internal walls of the stator and the walls of the rotors using a technique of immersing the body of the stator and the bodies of the rotors.

Other features and advantages of the invention will become apparent from the following description, given by way of example and without limitation, with reference to the appended drawings, in which:

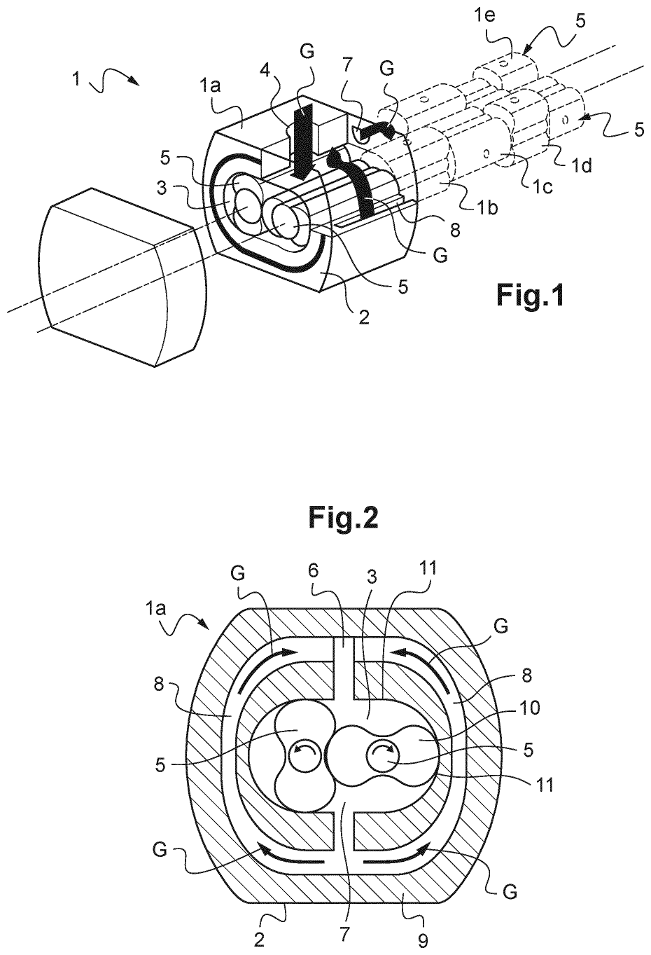

FIG. 1 shows a very schematic view of elements of a dry vacuum pump, in which only three quarters of the stator of the first pumping stage are shown.

FIG. 2 shows a very schematic view in cross section of a pumping stage of the vacuum pump in FIG. 1.

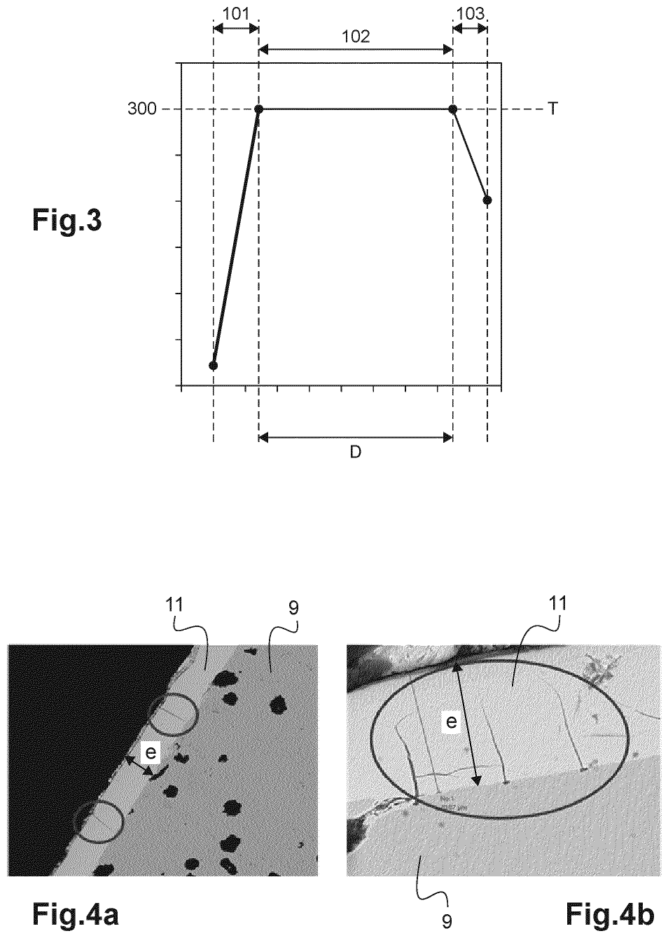

FIG. 3 is a graph showing an example of a temperature setpoint profile of a hardening heat treatment with the temperature (in ° C.) on the Y axis as a function of time (in hours) on the X axis.

FIG. 4a shows a scanning microscope photograph of a nickel-phosphorous coating that has undergone a hardening heat treatment.

FIG. 4b is an enlarged photograph of a detail in FIG. 4a.

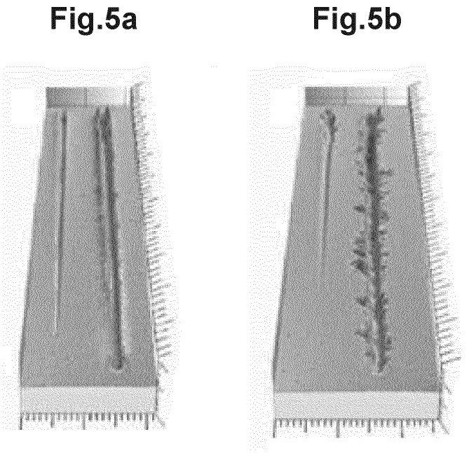

FIG. 5a shows a prior art coating sample in which a groove has been made.

FIG. 5b shows a nickel-phosphorous coating sample that has undergone a hardening heat treatment and in which a groove similar to the one made in the coating in FIG. 5a has been made.

In these figures, identical elements bear the same reference numerals.

The following embodiments are examples. Although the description refers to one or more embodiments, this does not necessarily mean that each reference relates to the same embodiment, or that the features apply only to a single embodiment. Individual features of various embodiments may also be combined or interchanged to provide other embodiments.

For ease of understanding, only those elements that are necessary for the operation of the pump have been shown.

The invention applies to any type of dry vacuum pump 1 having one or more stages, such as a “Roots” type vacuum pump, a double-claw or “claw” vacuum pump, a vacuum pump of the spiral or screw type or based on another similar principle, which are notably used in certain manufacturing methods, such as the manufacture of integrated circuits, photovoltaic solar cells, flat panel displays and light-emitting diodes, these methods involving steps entailing the evacuation of corrosive reactive gases from method chambers, the inlet of the vacuum pump being connected to the method chamber and the outlet being connected to gas treatment devices, prior to the release of the treated gases into the atmosphere.

FIG. 1 shows an exemplary embodiment of a dry vacuum pump 1, such as a rough-vacuum pump 1 configured to deliver the pumped gases at atmospheric pressure.

The vacuum pump 1 has a stator 2 (or pump body) forming at least one pumping stage 1a-1e.

The vacuum pump 1 has for example at least two pumping stages 1a-1e mounted in series between an intake 4 and a delivery of the vacuum pump 1 and in which a gas to be pumped can circulate (the direction of circulation of the pumped gases is illustrated by the arrows G in FIG. 1). The pumping stage 1a that communicates with the intake 4 of the vacuum pump 1 is the stage with the lowest pressure and the pumping stage 1e that communicates with the delivery is the stage with the highest pressure.

In the illustrative example, the vacuum pump 1 has five pumping stages 1a-1e.

Each pumping stage 1a-1e defines a compression chamber 3 of the stator 2 accommodating two rotors 5 of the vacuum pump 1, the chambers 3 each comprising an inlet 6 and an outlet 7 (FIG. 2). The compression chambers 3 of the successive pumping stages 1a-1e are connected in series one after another by in each case at least one inter-stage channel 8 connecting the outlet 7 of the preceding pumping stage to the inlet 6 of the following pumping stage. The inter-stage channels 8 are for example provided in the body 9 of the stator 2, for example next to the compression chamber 3. There are for example two inter-stage channels 8 per pumping stage, which are connected in parallel between the outlet 7 and the inlet 6 and arranged on either side of the compression chamber 3.

The rotors 5 have for example lobes with identical profiles, for example of the “Roots” or “claw” type, or are of the screw type or based on another similar positive-displacement vacuum pump principle.

The rotors 5 are configured to rotate synchronously in opposite directions in the pumping stages 1a-1e (FIG. 2). During rotation, the gas drawn in through the inlet 6 is trapped in the volume created by the rotors 5 and the compression chamber 3 of the stator 2 of the pumping stage, and is then compressed and driven by the rotors 5 towards the following stage.

The rotors 5 are driven in rotation by a motor of the vacuum pump 1 that is situated for example at one end. The vacuum pump 1 is notably configured to rotate at more than 40 Hz, such as between 50 Hz and 150 Hz.

The vacuum pump 1 is called “dry” since, in operation, the rotors 5 rotate inside the stator 2 without any mechanical contact between them or with the stator 2, and this allows there to be no oil in the compression chambers 3.

The body 9 of the stator 2 and the bodies 10 of the rotors 5 are made for example from cast iron or steel. They are made for example from spheroidal graphite cast iron, such as a ferritic cast iron also called SG cast iron.

During the method for manufacturing a vacuum pump 1, a nickel-phosphorus coating 11 is deposited on the internal wall of the body 9 of the stator 2 and on the walls of the bodies 10 of the rotors 5.

The nickel-phosphorus coating 11 is deposited for example on all the walls of the vacuum pump 1 that are likely to be in contact with the gas to be pumped, notably on the internal walls of the compression chambers 3 and on the walls of the inter-stage channels 8 that are provided in the body 9 of the stator 2.

The nickel-phosphorus coating 11 is deposited for example using a technique of immersing the body 9 of the stator 2 and the bodies 10 of the rotors 5.

The nickel-phosphorus coating 11 comprises between 9% and 14% phosphorous by weight, such as between 10% and 13% phosphorus. It also has a thickness e greater than 20 μm.

Next, the nickel-phosphorus coating 11 of the stator 2 and of the rotors 5 is heat treated with a step 102 of heating to a treatment temperature T greater than 250° C. for a treatment duration D greater than one hour, so as to have a hardness greater than 700 H_{V} (Vickers hardness under a load of 0.1 kgf), for example a hardness of between 800 H_{V} and 1000 H_{V}.

This hardening heat treatment is performed so as to precipitate and crystallize compounds of the nickel-phosphorus coating 11 so as to increase its hardness. The hardening heat treatment has to be performed on the nickel-phosphorus coating 11 of the stator 2 and on the nickel-phosphorus coating 11 of the rotors 5 in order to benefit from the improvement in the coefficient of friction between the two.

The thickness e is for example less than or equal to 60 such as 25 μm+/−5 μm (FIG. 4a). A greater thickness e increases the cost and the deposition time of the nickel-phosphorus coating 11.

The treatment temperature T of the heating step 102 is for example less than 350° C. It is for example 300° C.+/−20° C.

The treatment duration D of the heating step 102 is for example greater than eight hours. It is for example less than 15 hours.

A treatment duration D greater than eight hours allows the microstructure of the coating 11 to be made uniform. This treatment duration D also makes it possible to limit the internal stresses in the coating 11 and thus to make it tougher. In addition, the treatment duration D greater than eight hours allows the hydrogen gas that is trapped in the coating 11 during the phase of depositing the coating 11 to be degassed.

By contrast, a treatment duration D greater than 15 hours risks not allowing the desired hardening qualities to be obtained.

The proportion of phosphorous of between 9% and 14% phosphorous is called “high phosphorous”, in contrast to the proportions called “low phosphorous” having between 1% and 3% by weight phosphorous or “mid phosphorous” having between 6% and 8% phosphorous.

This high proportion of phosphorous allows the desired hardness behaviour to be obtained with said hardening heat treatment: the hardness of the “high phosphorous” nickel-phosphorus coating 11 increases and stabilizes substantially at a high level while it has a tendency to increase in hardness more quickly but then to decrease with the treatment duration for a coating of the “low phosphorous” type.

The hardening heat treatment is performed for example in an industrial furnace.

The hardening heat treatment may involve for example at least one temperature raising step 101 during which the temperature setpoint is increased from ambient temperature to the treatment temperature at a raising rate of between 1° C./min and 3° C./min.

These temperature raising rates allow an acceptable compromise to be obtained between a treatment duration that is relatively short for an industrial process and a rate that is slow enough to avoid the creation of excessively violent forces at the interface situated between the nickel-phosphorus coating 11 and the internal wall of the stator 2 or at the interface situated between the nickel-phosphorus coating 11 and the bodies 10 of the rotors 5. Specifically, the coefficients of thermal expansion are slightly different.

FIG. 3 shows an example of a temperature setpoint profile during a hardening heat treatment.

Although the treatment temperature of the heating step 102 effectively obtained in an industrial furnace may be relatively stable, the temperature may be relatively variable during the temperature raising and lowering steps, and also during the transitional phases, notably during the level stabilization phases, in particular on account of the relatively high inertia of the furnaces.

The temperature setpoint profile involves a first temperature raising step 101 of two hours, during which the temperature setpoint is increased from ambient temperature to the treatment temperature.

Then, the hardening heat treatment comprises the actual heating step 102, during which the treatment temperature is kept at more than 250° C., in this case at 300° C. for over an hour, for example for over 8 hours, in this case for 12 hours.

Finally, the hardening heat treatment involves a temperature lowering step 105 of two hours, during which the temperature setpoint is decreased from 300° C. to 200° C.

Then, the heating is stopped in order to let the stator 2 and the rotors 5 cool to ambient temperature.

The hardening of the coating 11 by heat treatment makes it more brittle as a result of the creation of microcracks in the microstructure of the coating 11 (FIGS. 4a, 4b).

In the event of mechanical contact between the rotors 5 and the stator 2 or between the rotors 5, the coating 11 flakes off and is dispersed in the form of dust. This is illustrated in FIG. 5b, which shows a nickel-phosphorous coating sample that has undergone a hardening heat treatment and in which a groove has been made. The edges of the groove have flaked off and dispersed. The coating has not deformed into bulges as shown in FIG. 5a, which shows a coating without hardening heat treatment.

The particles likely to be created during use as a result of contact between the rotors 5 and the stator 2 or between the rotors 5 can therefore be easily evacuated progressively by the pumping without preventing the vacuum pump 1 from continuing to rotate. Seizing can thus be avoided.

Furthermore, the nickel-phosphorus coating 11 makes it possible to avoid the formation of corrosion layers in the vacuum pump 1. The heat treatment for hardening the coating 11 thus makes it possible to improve the resistance of the vacuum pump 1 to corrosive gases and abrasion.

It also makes it possible to increase the regulation temperature of the body 9 of the stator 2 of the vacuum pump 1 so as to avoid the condensation-solidification of the reaction by-products and therefore to avoid the formation of deposits of condensable entities that are likely to cause the vacuum pump 1 to seize.

The hardened nickel-phosphorus coating 11 therefore makes it possible to reduce the risk of the vacuum pump 1 seizing.

1-15. (canceled)

16. A dry vacuum pump comprising:
a stator and two rotors that are accommodated in at least one compression chamber of the stator, the rotors being configured to rotate synchronously in opposite directions so as to drive a gas to be pumped between an intake and a delivery of the vacuum pump,
wherein the rotors and the compression chamber of the stator are coated with a nickel-phosphorus coating comprising between 9% and 14% phosphorus and having a thickness greater than 20 μm, the nickel-phosphorus coating having undergone a hardening heat treatment comprising a step of heating to a treatment temperature greater than 250° C. for a treatment duration greater than one hour, so as to have a hardness greater than 700 HV.

17. The vacuum pump according to claim 16, wherein the treatment duration is greater than 8 hours.

18. The vacuum pump according to claim 16, wherein the treatment duration is less than 15 hours.

19. The vacuum pump according to claim 16, wherein the hardness is between 800 HV and 1000 HV.

20. The vacuum pump according to claim 16, wherein the treatment temperature is less than 350° C.

21. The vacuum pump according to claim 16, wherein the nickel-phosphorus coating comprises between 10% and 13% phosphorus.

22. The vacuum pump according to claim 16, wherein the thickness of the nickel-phosphorus coating is less than or equal to 60 μm.

23. The vacuum pump according to claim 16, wherein the thickness of the nickel-phosphorus coating is 25 μm+/−5 μm.

24. The vacuum pump according to claim 16, further comprising:
at least two pumping stages each defining a compression chamber, the compression chambers of the successive pumping stages being connected in series by at least one inter-stage channel provided in a body of the stator that is also provided with a nickel-phosphorus coating.

25. The vacuum pump according to claim 24, wherein the nickel-phosphorus coating covers all the walls of the vacuum pump that are likely to be in contact with the gas to be pumped.

26. The vacuum pump according to claim 24, wherein the body of the stator and the bodies of the rotors are made from cast iron or steel.

27. The vacuum pump according to claim 16, wherein the rotor is configured to rotate at more than 40 Hz.

28. A method for manufacturing a dry vacuum pump, comprising:
depositing a nickel-phosphorus coating comprising between 9% and 14% phosphorus and having a thickness greater than 20 μm on an internal wall of a stator and on walls of rotors of the dry vacuum pump, and
heat treating the nickel-phosphorus coating of the stator and of the rotors by heating to a treatment temperature greater than 250° C. for a treatment duration greater than one hour, so as to have a hardness greater than 700 HV.

29. The method for manufacturing the vacuum pump according to claim 28, wherein the hardness is between 800 HV and 1000 HV.

30. The method for manufacturing the vacuum pump according to claim 28, wherein the treatment duration is greater than 8 hours and/or less than 15 hours.

31. The method for manufacturing the vacuum pump according to claim 28, wherein the hardening heat treatment involves at least one temperature raising step during which the temperature setpoint is increased from ambient temperature to the treatment temperature at a raising rate of between 1° C./min and 3° C./min.

32. The method for manufacturing the vacuum pump according to claim 28, wherein the nickel-phosphorus coating is deposited using a technique of immersing a body of the stator and bodies of the rotors.
